(19) United States
(12) Patent Application Publication
(10) Pub. No.: US 2014/0198487 A1
(43) Pub. Date: Jul. 17, 2014

(54) LED Lamp with Asymmetric Cylindrical Lens for Poster Display Case

(71) Applicants: Thomas Tessnow, Weare, NH (US); Kim Albright, Warner, NH (US); Ronald E. Boyd, JR., Chichester, NH (US)

(72) Inventors: Thomas Tessnow, Weare, NH (US); Kim Albright, Warner, NH (US); Ronald E. Boyd, JR., Chichester, NH (US)

(73) Assignee: OSRAM SYLVANIA Inc., Danvers, MA (US)

(21) Appl. No.: 13/743,415

(22) Filed: Jan. 17, 2013

(51) Int. Cl. F21V 5/04; F21V 29/00

(52) U.S. Cl. CPC F21V 5/04; F21V 29/22
USPC 362/126; 362/235

(57) ABSTRACT

A replacement lamp for a cinema poster display case. Light is produced by a linear array of white-light LEDs. In one example, a cylindrical lens is mounted longitudinally adjacent to the LEDs, and collects a central portion of the light emitted from the LEDs. In this example, a pair of inclined surfaces extend from the lateral edges of the LEDs to respective lateral edges of the cylindrical lens. The inclined surfaces have a rough surface texture and reflect light diffusely. The inclined surfaces collect a peripheral portion of the light emitted from the LEDs, and direct the reflected light toward the cylindrical lens. In this example, the LEDs, cylindrical lens and inclined surfaces are all mechanically supported by a heat sink. The cylindrical lens may include an asymmetry that directs more light toward the front face of the display case than toward the rear face.

### TECHNICAL FIELD

The present disclosure relates to cinema poster display cases.

### BACKGROUND

Cinema poster display cases, sometimes referred to as display signs, have been in use for many years, and are typically sized to accommodate a standard-sized movie poster. In the U.S., the standard film poster commonly displayed in theaters is known as a “one sheet”, which is 27 inches wide by 40 inches tall. Other countries have their own standard terminologies and sizes.

For a theatrical engagement of a particular movie, a poster arrives in the mail, rolled up in a tube from the respective film distributor. The poster is unrolled and placed in the front of a sign, which usually has a clamping mechanism to hold the poster against the front panel of the sign. At the end of the movie engagement, the poster is removed from the sign.

In a typical cinema sign, the movie poster is illuminated from the back and viewed from the front. These posters usually have a left-right inverted image of the front side printed on the back side, so that when viewed in back-lit illumination, the poster forms a single image with generally high contrast. Such posters may be referred to as “double sided”.

Initially, these movie signs used incandescent lamps as their light sources. In recent years, the incandescent lamps have been replaced by fluorescent lamps. The standard “one sheet”-sized cinema sign has fluorescent tubes extending vertically along the left and right edges of the poster area of the sign. When displayed in the sign, the poster is disposed at the front panel of the sign, and is typically about five inches in front of the back surface of the sign.

In recent years, light-emitting-diodes (LEDs) have emerged as a new technology for illumination and lighting applications. LEDs have potential advantages over fluorescent lamps in that they may be more efficient, may produce less heat, may having longer lifetimes, and may function more efficiently at cold temperatures. For these reasons and others, there has been a recent effort to incorporate LEDs into cinema signs. For example, a known LED-based display device is discussed in U.S. Pat. No. 7,841,733 (Meulenbelt).

### SUMMARY

An embodiment is a replacement light module. The replacement light module includes a heat sink elongated along a first direction, which can coincide with a vertical direction when the light module is installed in a cinema poster display case. The replacement light module further includes a plurality of LEDs supported by the heat sink. The LEDs are spaced apart in the first direction. Each LED emits light into an angular distribution centered around a respective surface normal. The replacement light module further includes a cylindrical lens elongated along the first direction. The lens receives a central portion of the light emitted from the LEDs and transmits the central portion therethrough. The lens alters the angular path of the transmitted light along a second direction but not along the first direction, the second direction coinciding with a forward direction when the light module is installed in a cinema poster display case. The lens has at least one asymmetric portion that produces an angular asymmetry of the transmitted light in the second direction but not in the first direction. The replacement light module further includes a pair of elongated, inclined surfaces on the heat sink. Each inclined surface is elongated along the first direction and is parallel to the first direction. Each inclined surface extends from a position proximate a lateral edge of the LEDs to a position proximate a lateral edge of the lens. The pair of inclined surfaces open away from the LEDs toward the lens. Each inclined surface receives a peripheral portion of the light emitted by the LEDs and diffusely reflects the peripheral portion toward the lens.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a perspective drawing of a movie poster display case.

FIG. 2 is a top-view schematic drawing of the display case of FIG. 1, with the fluorescent lamps still present.

FIG. 3 is a top-view schematic drawing of the display case of FIG. 1, with the fluorescent lamps removed and replaced by a single LED lamp.

FIG. 4 is a top-view schematic drawing of some angular variables that describe the geometry of the LED lamp in the display case.

FIG. 5 is a front-view schematic drawing of the display area of the display case.

FIG. 6 is a perspective drawing of an example set of pins that extend from the lamp.

FIG. 7 is a top-view drawing of the optical components of an example LED lamp.

FIG. 8 is a perspective drawing of the optical elements of FIG. 7.

FIG. 9 is a plot of calculated intensity as a function of propagation angle for the example configuration of FIGS. 7 and 8.

FIG. 10 is a top-view drawing of the optical components of another example LED lamp.

FIG. 11 is a plot of calculated intensity as a function of propagation angle for the example configuration of FIG. 10.

FIG. 12 is a top-view drawing of the optical components of another example LED lamp.

FIG. 13 is a plot of calculated intensity as a function of propagation angle for the example configuration of FIG. 12.

### DETAILED DESCRIPTION OF PREFERRED EMBODIMENTS INCLUDING BEST MODE

Because cinema poster display signs are typically mounted on the wall of a theater, and are generally a standard size, such as a “one sheet” in the U.S., it is beneficial to establish a convention for describing the various orientations and directions encountered in this document. Note that the term “vertical” refers to the direction perpendicular to the ground, or “up”. The terms “lateral” and “forward” are used in this document, where “lateral” denotes the “left”-to-“right” direction, which is parallel to the top edge of the sign and parallel to the ground, and “forward” denotes the direction perpendicular to the viewable face of the sign and parallel to the ground. In the drawings, the directions of vertical, forward and lateral are noted by the shorthand labels of X, Y and Z. It is understood that the terms lateral, forward and vertical describe orientations and directions not only when the sign is in use, but may also be used for convenience to describe the relative orientations of elements with respect to each other even when the sign is uninstalled, is inactive on a shelf or is in shipment.

Similarly, the term “generally” is used in this document to denote a typical direction, or a direction that is a combination of an intended direction with a slight misalignment caused by typical manufacturing, alignment or assembly tolerances.

A trend in many lighting or illumination applications is to use light emitting diodes (LEDs) as the light sources. Compared with most incandescent and fluorescent light sources, LEDs are more efficient, produce less heat, and have longer lifetimes. In particular, for cold-weather outdoor applications, LEDs operate significantly more efficiently than their incandescent or fluorescent counterparts. At the temperature drops, the efficiency of a typical LED increases, while the efficiency of a comparable fluorescent light decreases.

In keeping with the trend toward LEDs, there is a desire to retrofit existing cinema poster display signs, many of which currently use fluorescent lamps in their interiors, with LED light sources. Such a retrofit is significantly less expensive than a full replacement of the display sign. The LED-based lamps discussed herein are suitable for such a retrofit.

Movie theaters and film distributors in the U.S. have adopted a standard size for the movie posters that are displayed during a film's engagement in the theater. This standard size for the posters in the U.S. is typically known as a “one sheet”, which has dimensions of 27 inches wide by 40 inches tall. The display cases that are designed to accommodate the “one sheet” posters may optionally have a small buffer region of an inch or two along the vertical and/or horizontal dimensions, in order to accommodate slight variations in size from poster to poster.

Because the display signs have a standardized size, there is effectively only one variation of cinema display sign in the U.S. It therefore becomes relatively straightforward to envision a single retrofitting module, which can replace the older fluorescent lamps inside these “one sheet” signs.

Note that other countries have their own standardized sizes, which are generally different from the U.S. “one sheet”. It is contemplated that the designs and configurations contemplated in this document may be modified in a straightforward manner to accommodate the poster size in any particular country or region.

For a retrofit, one would first open a cinema sign to gain access to the interior of the sign. One would then remove the fluorescent lamps from the left edge and/or the right edge of the cinema sign. Typically, these lamps are elongated fluorescent tubes with electrical pins at their ends, which couple to respective pairs of so-called “tombstone” connectors. The fluorescent tubes are removed by first pivoting them about their elongated axes until the pins align with a channel in the connector, then pulling them out of the channels at the “tops” of the “tombstones”. New tubes are engaged with the tombstone connectors by inserting the pins through the tombstone channels, then pivoting the tubes about their elongated axes.

Once the left and/or the right fluorescent lamp have been removed, one may secure a single LED lamp in a pair of existing tombstone connectors at or near the left edge or the right edge of the cinema sign. Once the LED lamp is secured, one may close the cinema sign, energize the LED lamp through the appropriate tombstone connectors, and operate the cinema sign to inform passers-by about the respective movie on the poster.

In addition to having a relatively high efficiency, a relatively low heat output, and a relatively long lifetime, the retrofit LED lamp also simplifies lamp replacement, since it uses only one set of electrical sockets in the cinema sign, as opposed to using both sets for replacement of the fluorescent lamps.

When mounted and operational, the single LED lamp directs its output largely laterally. For instance, if the LED lamp is mounted on the left side of the sign, then its output is directed largely to the right side of the sign. Similarly, if the LED lamp is mounted on the right side of the sign, then its output is directed largely to the left side of the sign.

In addition to the lateral component, the output may be biased to direct more light toward the front of the sign and less light to the rear of the sign. This bias may result from some asymmetry in one or more of the optical elements in the LED lamp. In addition, in order to ensure that light from the LED lamp is biased toward the front of the sign and not the rear of the sign, it may be desirable to put one or more indicia on the lamp, such as an arrow, indicating where the front of the sign should be located when the LED lamp is installed.

In all of the configurations, light leaving the LED lamp at an angle truly parallel to the front face of the display case (along the Z-direction) misses the front face of the display case completely, and may be partially wasted when it strikes a lateral edge of the display case. As a result, all of the LED lamp configurations discussed herein have angular outputs that reduce propagation along the Z-axis by as much as is practical. For a typical design, about 80% of the LED lamp output strikes the front and rear faces, while only about 20% misses the front and rear faces. Three example designs are presented in the figures and are discussed in detail below, although other suitable variants may also be used.

In one of the three configurations shown in the figures and discussed in detail below, the LED lamp light output is directed away from the true lateral (Z) direction, and is split equally between front and rear. Light that would otherwise strike the lateral edge of the display case is diverted toward the front of the display case and toward the rear of the display case, with generally equal amounts of light being directed to the front and rear. This configuration relies on the reflectivity of the rear face of the display case, so that light striking the rear face of the display case may be diffusely reflected toward the front face of the display case.

Such a configuration may be particularly effective if the LED lamp is located halfway between the front and rear face of the display case. For such a symmetric geometry, an LED lamp configuration originally designed to work with a two-sided sign may be used for a symmetric one-sided display case with a reflective rear face.

In the remaining two of the three configurations shown in the figures and discussed in detail below, the LED lamp light output is divided asymmetrically between front and rear, with more light being directed to the front face than to the rear face.

Following a discussion of the geometry involved with a typical movie poster display case, the three configurations for the LED lamp are discussed, along with simulated intensity patterns for each.

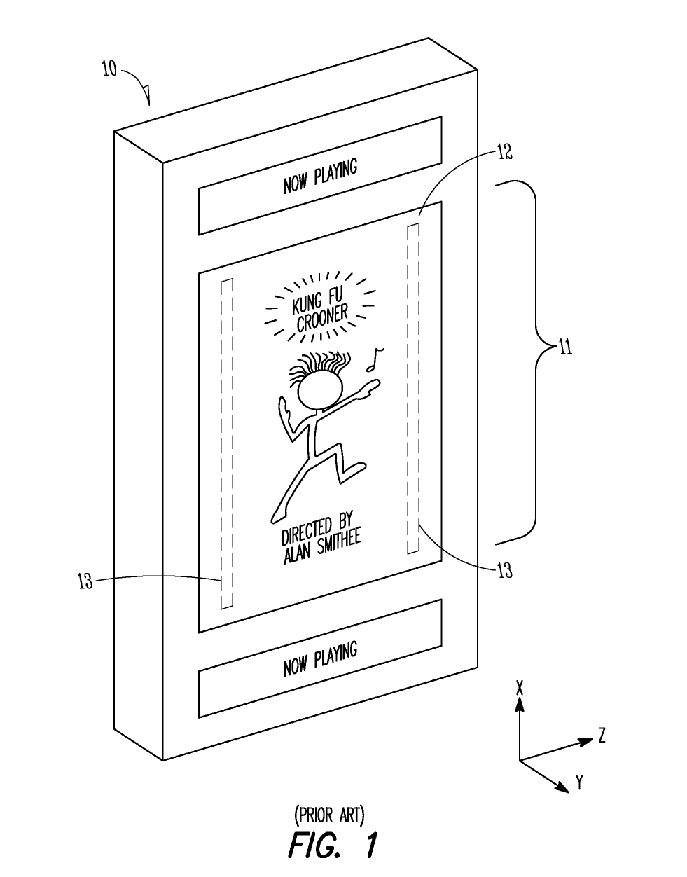

FIG. 1 is a perspective drawing of a movie poster display case 10. The case 10 has a display area 11, in which a movie poster may be displayed. The case 10 may optionally include additional regions on its front face that can include additional information, such as show times, or announcements such as “Now Playing” or “Coming Soon”. These additional regions may also use additional light sources; for the purposes of this document, we are primarily concerned with the display area 11.

FIG. 1 shows a set of coordinates for the display case 10. The X-direction is referred to as “vertical”, with “up” and “down” being along the +X and −X directions. The Y-direction is referred to as “forward”, with “in front of” and “behind” being along the +Y and −Y directions. The Z-direction is referred to as “lateral”, with “right” and “left” being along the +Z and −Z directions. These coordinates are used consistently throughout this document.

Note that although the coordinates (X, Y, and Z) and their accompanying descriptions of (vertical, forward, and lateral) describe orientations of the lamp and its elements when installed, they may also be used to describe orientations when the lamp is uninstalled. For instance, FIG. 1 shows lamps 13 installed in a display case 10. As installed, the lamps 13 are described as being elongated in the vertical (X) direction. When not installed, the lamps 13 may be moved around and positioned in any desired manner, but it remains convenient to describe their direction of elongation as being vertical (X), since this is the case when the lamps 13 are installed. It is understood that the designation of any one axis as the “vertical” axis is arbitrary, and is simply a matter of convenience.

The display case 10 is intended to be non-removably mounted on the wall of a movie theater, with a front face that can be opened to access the interior of the case 10 as needed. The interior may be accessed to change the movie poster, change the movie show times if listed on the case 10, replace a lamp, and so forth. Typically, the front face 12 is hinged along its left side and pivots outward, although the front face 12 may be attached in some other suitable manner. The case 10 has a mechanism for holding a poster against the front face 12, which may include clips to force the posted against a rear side of the front face 12, or a transparent backing surface that forms a pocket in which the poster can rest.

In the case of FIG. 1, the display area 11 is illuminated from two known fluorescent lamps 13, with each lamp 13 located along a respective lateral edge of the case 10, and extending at least partially along the length of the lateral edge of the case 10. It is intended that both fluorescent lamps 13 be removed, and that a single retrofit LED lamp be inserted into the electrical sockets for one of the fluorescent lamps 13. In this manner, a theater owner may keep the existing display case, but may upgrade the lighting within the case. The LED lamp is shown and discussed in greater detail below.

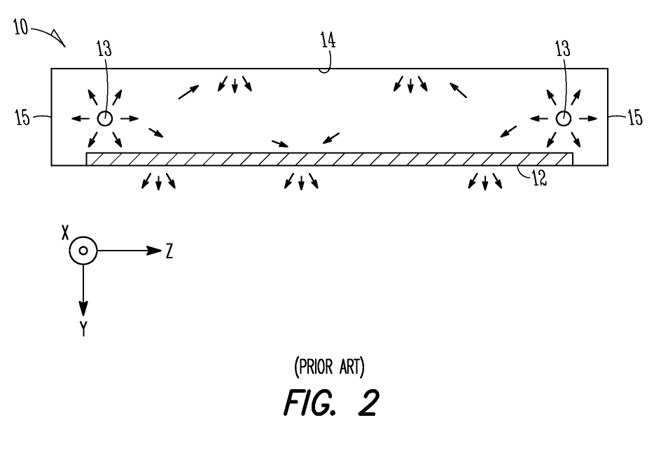

FIG. 2 is a top-view schematic drawing of the display case 10 of FIG. 1, with the fluorescent lamps 13 still present. The two fluorescent lamps 13 are disposed behind the front face 12, at or near the lateral edges of the poster. Light from the fluorescent lamps 13 exits the lamps generally uniformly in all directions. Some light strikes the front face 12 and the poster directly, and exits the display case 10 as useable light that may be viewed by a viewer. Some light strikes the rear face 14 of the display case 10, which is diffusely reflective, and is scattered in angle within the interior of the display case 10. Some light strikes the lateral (left and right) faces 15 of the display case, which may be reflective but typically absorb some of the light.

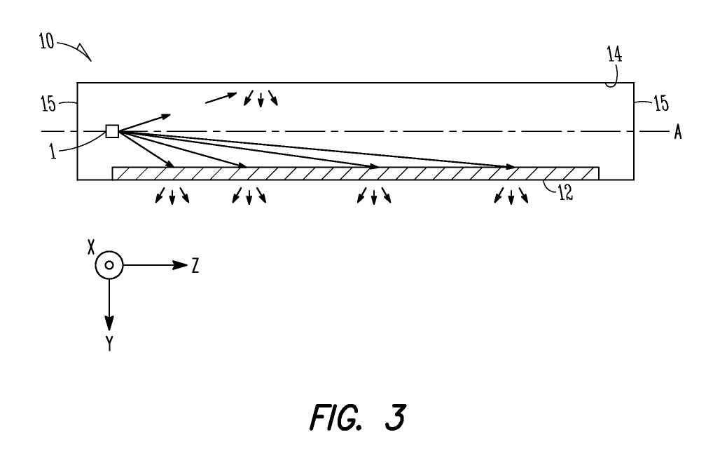

FIG. 3 is a top-view schematic drawing of the display case 10 of FIG. 1, with the fluorescent lamps 13 removed and replaced by a single LED lamp 1. It is intended that the LED lamp 1 be retrofit to use the existing electrical sockets that supplied power to the fluorescent lamps 13, so that no additional mounting hardware may be required.

For convenience, a longitudinal axis A is established, for each LED in the LED lamp. In practice, these longitudinal axes are all generally coplanar, so that in the top-down view of FIG. 3, all the longitudinal axes lie on top of each other, and are represented collectively by the notation of A.

For the remaining figures and discussion, it is assumed that the LED lamp 1 is installed in the leftmost set of electrical sockets in the case 10. It is understood that the LED lamp 1 may alternatively be installed in the rightmost set of electrical sockets in the case 10, where the suitable geometry may be reversed left-to-right from the geometry shown in the figures.

For the purposes of terminology, the term “proximal” is used to denote elements that are relatively close to the LED lamp 1, while “distal” is used to denote elements that are relatively far away from the LED lamp 1. In FIG. 3, the leftmost portion of the front face 12 may be referred to as a proximal region of the front face 12 of the case 10. Similarly, the rightmost portion of the front face 12 in FIG. 3 may be referred to as a distal region of the front face 12 of the case 10.

The front 12 and rear 14 faces of the case 10 are shown in FIG. 3 as being diffusive, where light at a single incident angle is transmitted or reflected into a range of exiting angles. For the front face 12, the diffusive properties are generally included with the poster itself, since the poster is printed on slightly diffusive material. The actual front face 12 of the case 10 is clear and is free from diffusive properties.

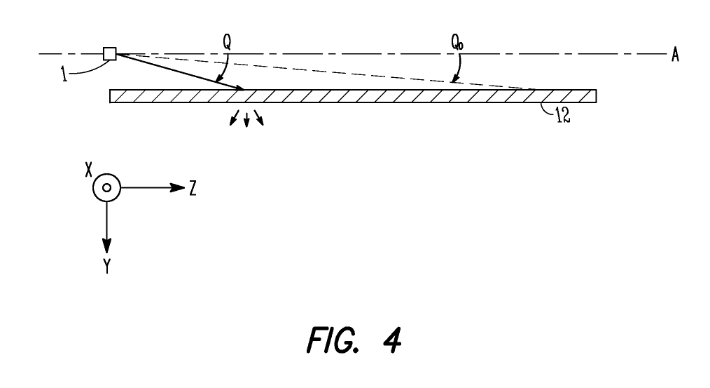

FIG. 4 is a top-view schematic drawing of some angular variables that describe the geometry of the LED lamp 1 in the display case 10. The angle Q describes the angular output from the LED lamp, in that intensity from the LED lamp 1 may be predicted and/or measured as a function of propagation angle Q. An angle Q of zero coincides with the lateral axis (Z). A positive value of Q is directed toward the front face 12 of the case 10 and toward the poster. A negative value of Q is directed toward the reflective rear face 14 of the case 10.

A particular angular value Q₀ describes the angle formed by a ray that extends from the LED lamp 1 to the distalmost lateral edge of the front face 12. This distalmost lateral edge of the front face 12 is intended to represent the location farthest away from the LED lamp 1 at which illumination is required or desired. In other words, the poster generally extends laterally only as far as this distalmost lateral edge, so that light is provided to the front face 12 only to this edge. Any illumination delivered beyond this distalmost lateral edge, corresponding to propagation angles between zero and Q₀, may be considered wasted, and may be reduced by as much as is practical at the design phase of the LED lamp 1.

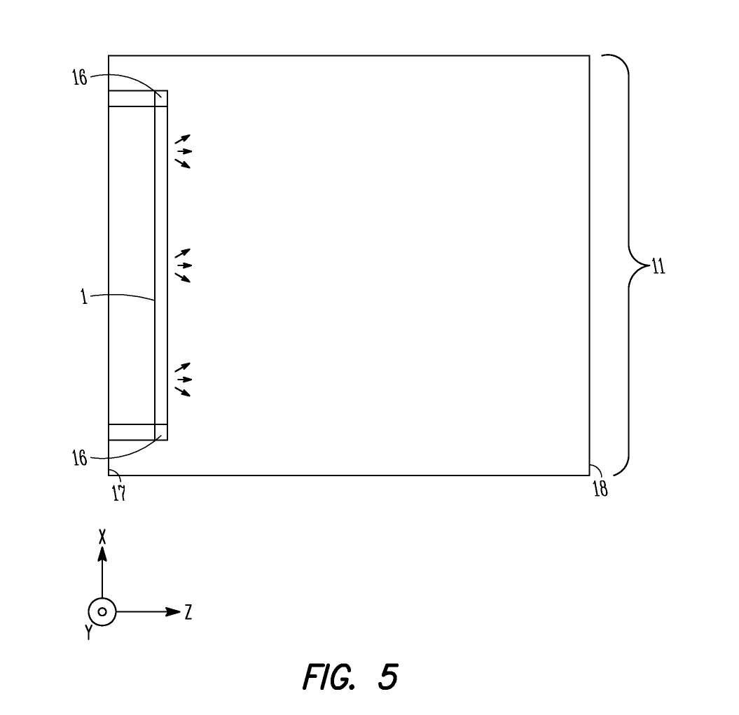

FIG. 5 is a front-view schematic drawing of the display area 11 of the display case 10, looking through the front face 12 as if observing a displayed poster in the case 10. In FIG. 5, the fluorescent lamps 13 have been removed and replaced by a single LED lamp 1. The lamp 1 may be installed using the same electrical sockets 16 that were used for the fluorescent lamps. It is intended that the existing electrical sockets 16 may mechanically support the lamp 1, and may also electrically power the LEDs in the lamp 1. In this respect, it is intended that the lamp 1 may be truly a retrofit item, which may not require any additional mechanical hardware, or any mechanical or electrical modifications to the display case 10. In addition, it is intended that the LED lamp 1 fit into the same footprint or volume envelope as the fluorescent lamp 13 that it replaces.

Note that the LED lamp 1 may be installed along either lateral edge of the display case 10. In FIG. 5, the LED lamp 1 has been installed at the left edge 17 of the case 10, although the LED lamp 1 may alternatively be installed at the right edge 18 of the case 10. In general, because the lamp emission pattern may be asymmetric, it may be desirable to ensure that the lamp 1 is not installed upside down. Such an installation may result in more light being directed to the rear face 14 of the display case 10 and less light being directed to the front face 12 and the poster.

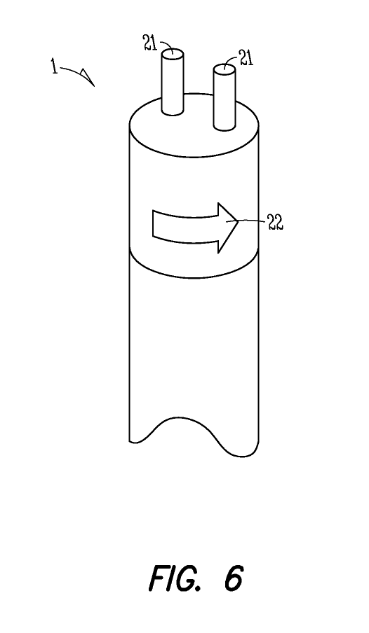

In order to prevent such upside-down installation, it may be useful to have one or more identifying marks or indicia on the lamp 1 to identify a desired orientation of the lamp 1. FIG. 6 is a schematic drawing of one end of the LED lamp 1, which shows an example of an identifying mark 22. In this example, the identifying mark 22 is an arrow, which may indicate a front of the display when installed properly. There are many other suitable indicia that can visually indicate to a user which end of the lamp 1 should be installed in which socket 16, all of which should be known to one of ordinary skill in the art. As an alternative, there may also be a locking mechanism, such as a clip or a ridge, which may serve the same purpose as the indicia or identifying mark 22 in preventing upside-down installation of the lamp 1.

FIG. 6 also shows an example set of pins 21 that extend from the lamp 1, and can couple with the socket 16. In general, it is intended that the pin configuration of the LED lamp 1 match the pin configuration used on the fluorescent lamps. Such a pin configuration will be relatively standardized, and will be readily known to one of ordinary skill in the art.

In the preceding paragraphs, it is assumed that the LED lamp 1 is a direct replacement for one of the fluorescent lamps 13, and uses the same electrical and mechanical connections as the fluorescent lamp 13. As an alternative, the ballast and electrical sockets for the fluorescent lamps may also be removed, and one or more new mounting brackets may be installed for the replacement LED lamp 1. The LED lamp 1 may use a ballast that is built into the lamp 1, or may use an external ballast that is installed along with the new mounting bracket in the display case. In all cases, it is assumed that the fluorescent or incandescent system that is removed uses two or more fluorescent or incandescent lamps, and that the LED system that is installed uses only a single LED lamp 1.

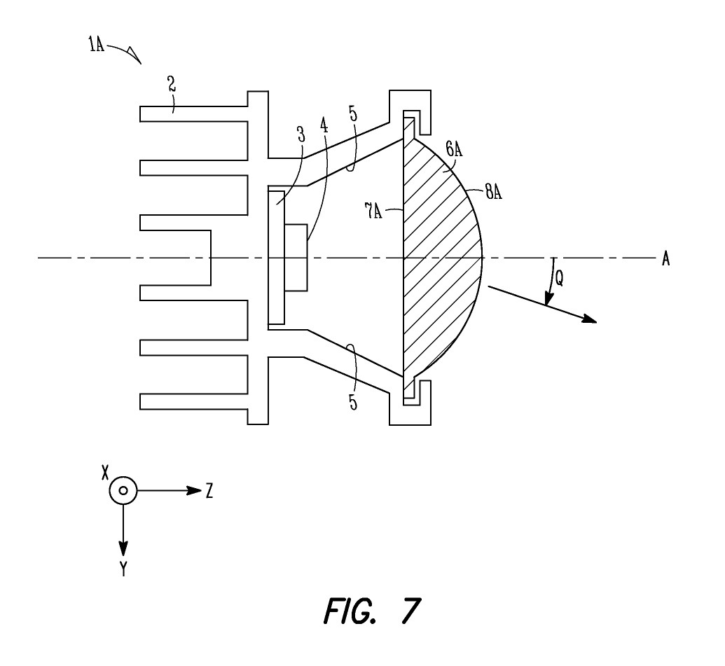

Note that lamp 1 may include an optional cylindrical housing that can protect the optical elements of the lamp from damage and contamination. Alternatively, the housing may expose all or part of a heat sink, which may be used to dissipate heat generated by the LEDs in the lamp 1. It is assumed that a suitable housing configuration is used, and that such a housing will be known to one of ordinary skill in the art.

Whereas FIGS. 1-6 and the accompanying text have presented the LED lamp 1 in general terms, FIGS. 7-13 and the text below present three example configurations 1A, 1B and 1C for the LED lamp 1. It is understood that other suitable configurations may also be used.

FIG. 7 is a top-view drawing of the optical components of example LED lamp 1A, looking down into the top of the display case 10 as in FIG. 4. In particular, where the LED lamp 1A is elongated and shaped to match the fluorescent tubes that it replaces, FIG. 7 is a cross-sectional view. Specifically, the actual LED lamp 1A includes several LEDs, but only one LED is shown in the cross-section of FIG. 7; the other LEDs in FIG. 7 would be located out of the plane of the page, toward the viewer and/or away from the viewer.

A heat sink 2 is elongated along the vertical (X) direction. Most or all of the additional elements are attached to or are integral with the heat sink 2.

The heat sink 2 supports a series of LEDs 3 that are also distributed along the vertical (X) direction. In some cases the LEDs 3 are evenly distributed. The LEDs 3 emit white light, typically by producing blue or violet light and including a phosphor that absorbs the blue or violet light and emits light in the yellow portion of the spectrum. The combination of the blue or violet source light with the yellow phosphor-emitted light appears white to the human eye.

Each LED 3 typically has a generally square emission face 4, and emits light into an angular distribution that is centered around a longitudinal axis (A). The longitudinal axes (A) of all the LEDs 3 are parallel to each other and are generally parallel to the lateral axis (Z). The angular distribution is typically Lambertian, with an intensity that peaks along the longitudinal axis (A), and falls to zero at ninety degrees from the longitudinal axis (A).

The light emitted from the LEDs 3 is characterized by propagation angle. (Note that this propagation angle discussed in this paragraph is not labeled as Q, but instead is between the LED emission face 4 and the lens 6A. Q is the propagation angle of the entire lamp 1A.)

We define a central portion of the LED light to mean the light propagating along the longitudinal axis (A) and at relatively small propagation angles on either side of the longitudinal axis (A). This central portion leaves the LEDs 3 and directly strikes an incident face 7A of a cylindrical lens 6A.

We also define a peripheral portion of the LED light to mean the light propagating at relative large propagation angles with respect to the longitudinal axis (A). This peripheral portion leaves the LEDs 3 and directly strikes one of two inclined surfaces 5, which diffusely reflects the light toward the incident face 7A of the cylindrical lens 6A. The inclined surfaces 5 are either integral with the heat sink 2 or are made separately and are attached to the heat sink 2.

The inclined surfaces 5 are generally flat, to within reasonable manufacturing tolerances. Alternatively, the inclined surfaces 5 may be convex, concave, or a combination of convex and concave.

The inclined surfaces 5 are diffuse reflectors. As such, the surfaces 5 are rough enough to produce diffuse reflections, rather than specular reflection. For the purposes of this document, a “diffuse” reflection is taken to mean a “non-specular” reflection. For a specular reflector, light striking the specular reflector at a single angle of incidence is reflected into a single angle of reflection. In contrast, for a diffuse reflector, light striking the diffuse reflector at a single angle of incidence is reflected into a range of reflected angles. The inclined surfaces 5 may be formed with the surface roughness being integral with a molding process, or may alternatively be formed as smooth surfaces that are roughened afterward. One of ordinary skill in the art will be readily familiar with the amount of surface roughening that produces a fully diffuse reflector (light scatters into an angular distribution centered around a surface normal, regardless of the angle of incidence) or a partially diffuse reflector (light scatters into an angular distribution centered around the angle of reflection of a specular reflection).

The orientation of the inclined surfaces 5 are described as being parallel to a vertical direction (X), and extending from a position at or near a lateral edge of the LEDs 3 to a position at or near a lateral edge of the cylindrical lens 6A. The inclined surfaces 5 open outward from the LEDs 3 to the lens 6A. The lens 6A may be mechanically supported by the heat sink 2.

The light passing through the cylindrical lens 6A is a combination of central light, which leaves the LEDs 3 and directly strikes the incident face 7A of the lens 6A, and peripheral light, which leaves the LEDs 3 and reflects diffusely off the inclined surfaces 5. Most or all of this light transmits through the incident face 7A and the exiting face 8A of the lens 6A.

The cylindrical lens 6A has optical power in the forward direction (Y) but not in the vertical direction (X). In other words, the cylindrical lens 6A alters the angular path of the transmitted light along the forward direction (Y) but not along the vertical direction (X). In the exemplary configuration shown in the figures, the cylindrical lens 6A is plano-convex, with a generally flat incident side 7A. In other configurations, the cylindrical lens 6A may be bi-convex or meniscus.

In the specific configuration shown in the figures, the convex exiting side 8A of the lens 6A is convex across the full surface. In some configurations, the convex exiting side 8A of the lens 6A is flat at the intersection with the longitudinal axis (A). In some other configurations, there may be a slight concave dimple at the intersection with the longitudinal axis (A).

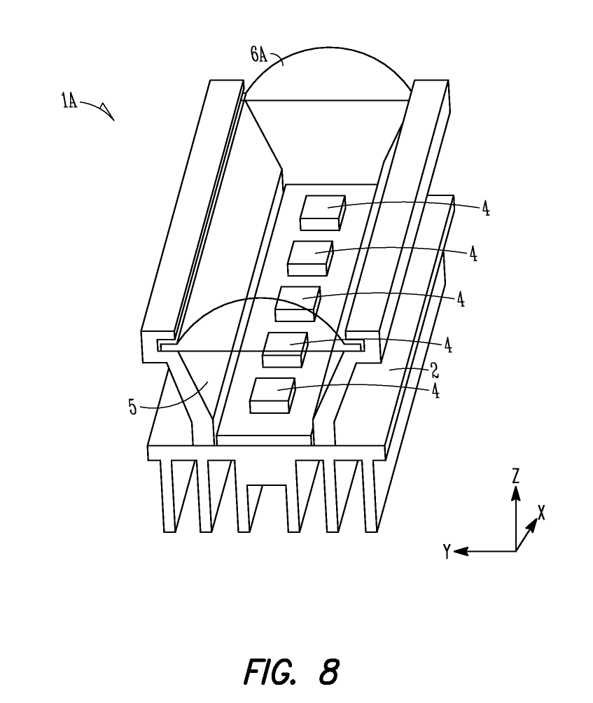

FIG. 8 is a perspective drawing of the optical elements shown in FIG. 7. FIG. 8 more clearly shows the multiple emission faces 4 for the respective LEDs, and the single cylindrical lens 6A that receives the light from the multiple LEDs.

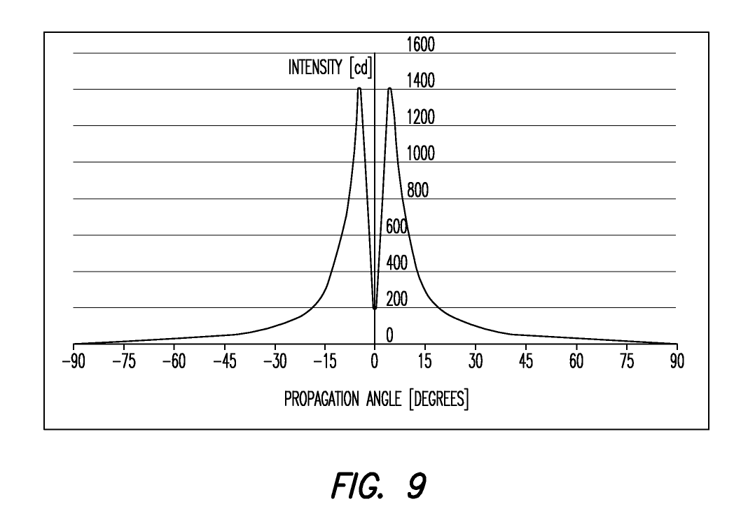

FIG. 9 is a plot of calculated intensity, in candelas, as a function of propagation angle Q, in degrees, for the example configuration of FIGS. 7 and 8. The plot shows strong peaks at roughly plus four degrees and minus four degrees, with a sharply reduced intensity between the peaks, and a trail-off at propagation angles higher than the peaks. The peaks correspond roughly to the angle Q₀ from FIG. 4.

Simulations were performed with ASAP, which is computer aided designing software that is well suited for lighting design tasks. ASAP is commercially available from Breault Research Organization, Inc. in Tucson, Ariz. It is understood that any suitable ray-tracing software may also be used for the simulation of performance, and the adjustment of various system parameters to optimize performance.

Note that the example LED lamp 1A of FIGS. 7 and 8 is generally symmetric about the longitudinal axis (A). The light emission from the example LED lamp 1A is generally evenly split between the forward-propagating light, which strikes the front face 12 of the display case 10, and backward-propagating light, which strikes the rear face 14 of the display case 10. The backward-propagating light is diffusely reflected by the rear face 14, and may eventually be directed to the front face 12 and the poster.

It may be convenient to have a simple formula that predicts the shape of the decay of the curve of FIG. 9 at high propagation angles. Such a formula is empirically found to be:

I(Q)=I(Q₀)*(sin Q₀)̂E/(sin Q)̂E

where I is the intensity in candelas, Q is the angle of propagation, Q₀ is the propagation angle at which the distribution peaks (about four degrees in the present example), and E is a dimensionless exponent that is found to have a value between 1.5 and 3. For the special case of a single LED and no reflective elements inside the lamp 1, E is found to have a value of 3. For the example design of FIGS. 7 and 8, E is found to be 1.6.

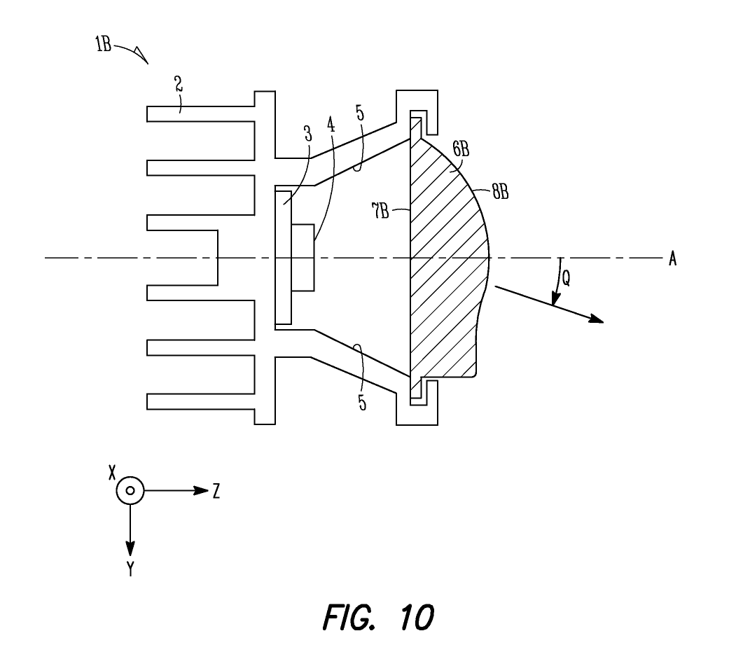

In contrast with the symmetric design of FIGS. 7 and 8, there may be asymmetric designs in which more light is directed to the front face 12 than to the rear face 14. Two such example LED lamps 1B and 1C are shown in FIGS. 10-13 and are discussed presently.

FIG. 10 is a top-view drawing of the optical components of example LED lamp 1B, looking down into the top of the display case 10 as in FIG. 4. A difference between this design and the symmetric design of FIG. 7 is that the lens 6B is asymmetric.

Compared with the symmetric lens 6A of FIG. 7, the asymmetric lens 6B of FIG. 10 has a protrusion on the forward-most (+Y) portion of the exiting face 8B. The incident face 7B of the lens 6B is generally planar.

An explanation of the effect of such a protrusion is presently provided. Such a protrusion makes the exiting face 8B of the lens 6B look “flatter”, or more planar, to the incident light. Because the exiting face 8B appears flatter, or less curved, the exiting face 8B may appear to have less optical power, so that light passing through the protrusion is bent less by the exiting face 8B. Therefore, light traveling downward (+Y) from the LED 3 and passing through the protrusion in the exiting face 8B continues its downward (+Y) trajectory moreso than if the protrusion were absent. As a result, the asymmetric lens 6B produces more light traveling downward (+Y, Q>0), toward the front face 12 of the display case 10, than rearward (−Y, Q<0), toward the rear face 14 of the display case 10.

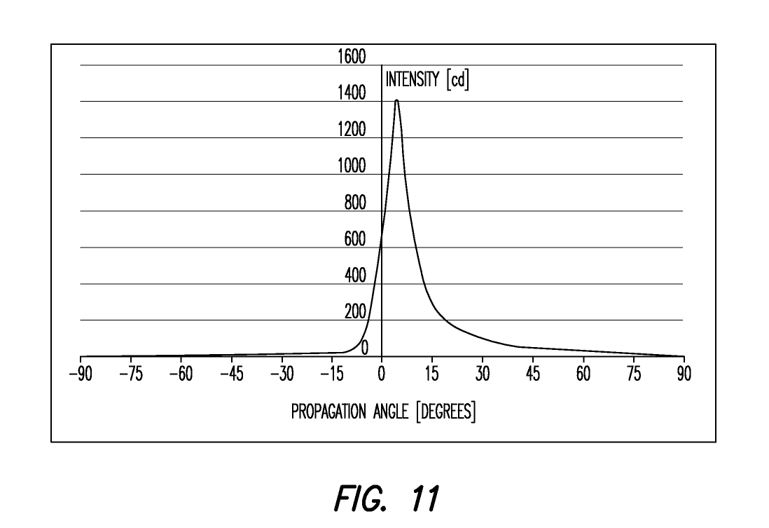

FIG. 11 is a plot of predicted intensity, in candelas, versus the propagation angle Q, for the example LED lamp 1B of FIG. 10 that uses the asymmetric lens 6B. Here, a single peak is seen, corresponding roughly to angle Q₀. Unlike the two-peak distribution of FIG. 9 that directs nearly half the light toward the rear face 14 (Q<0), the single-peak distribution of FIG. 11 directs most of its light toward the front face 12 (Q>0) and relatively little light toward the rear face 14 (Q<0).

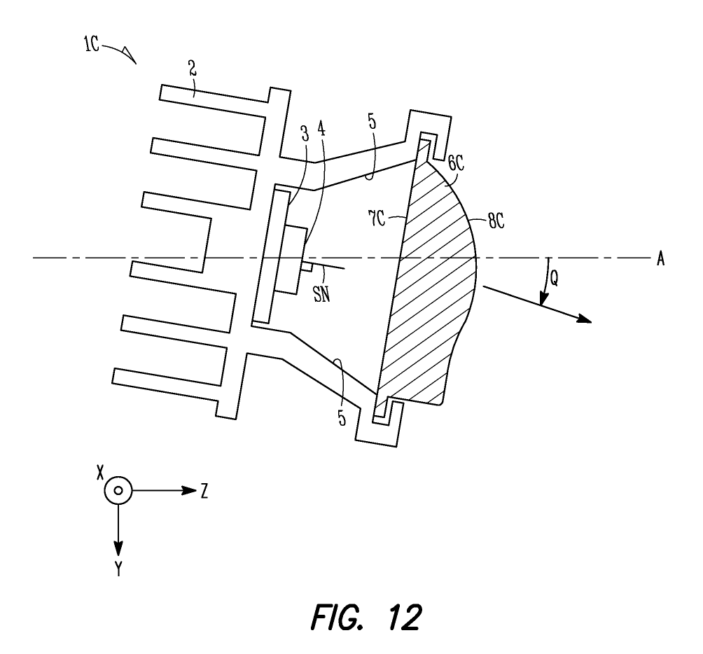

In addition to including a protrusion on the exiting face 8B of the lens 6B, as shown in FIG. 10, there are other ways to impart an asymmetry on the output of the LED lamp 1. For instance, FIG. 12 shows an LED lamp 1C with a similar structure to that of FIG. 10, but with its heat sink 2, LED 3, and lens 6C tilted with respect to the longitudinal axis A. Here, the emission face 4 of the LED 3 has a surface normal SN, which is tilted with respect to the longitudinal axis A. The example lens 6C may also include a generally planar incident face 7C and a generally convex exiting face 8C that may also include a protrusion. Here, the asymmetric effects of the tilting may be used to augment the asymmetry caused by the protrusion; as an alternative, the tilting asymmetry may be used to fully, partially, or overly compensate for the protrusion asymmetry.

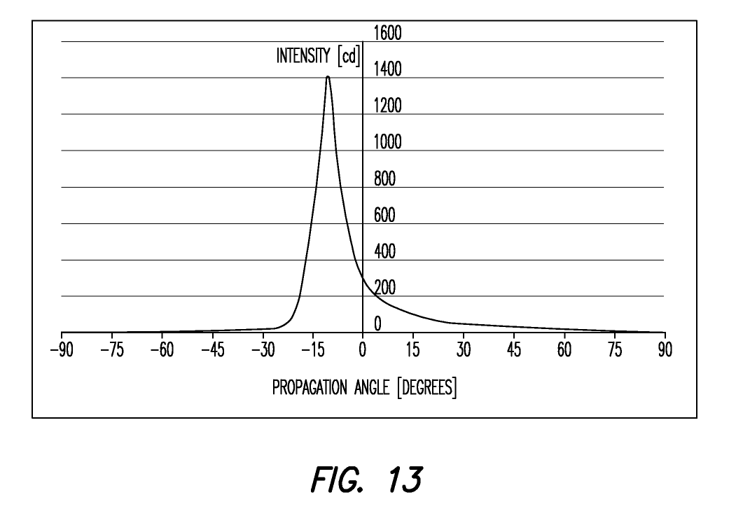

FIG. 13 is a plot of predicted intensity, in candelas, versus the propagation angle Q, for the example LED lamp 1C of FIG. 12 that uses the asymmetric lens 6C and is tilted. Here, the tilting is used to offset the protrusion effect.

There are other LED lamp designs similar to those in FIGS. 10 and 12, which may also include similarly asymmetric outputs. For instance, the incident face may be curved, rather than generally planar, and the curvature may include its own suitable protrusion. As another example, the entire lens may be shifted toward the front face 12 of the display case 10, while the LEDs remain stationary. This shift would be downward in FIGS. 10 and 12. Other modifications to the basic design of FIGS. 10 and 12 may be made as well.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

GLOSSARY: a non-limiting summary of above reference numerals
1 LED lamp
1A, 1B, 1C example LED lamps
2 heat sink
3 LEDs
4 emission faces of LEDs
5 inclined surfaces
6A, 6B, 6C example cylindrical lenses
7A, 7B, 7C incident faces of cylindrical lenses
8A, 8B, 8C exiting faces of cylindrical lenses
10 movie poster display case
11 display area of display case
12 front face of display case
13 fluorescent lamps
14 rear face of display case
15 lateral faces of display case
16 electrical sockets
17 left edge of display case
18 right edge of display case
21 pins
22 identifying mark
A longitudinal axis
SN surface normal of LED emission face
Q propagation angle of LED lamp light output
X vertical direction
Y forward direction
Z lateral direction

What is claimed is:

1. A replacement light module (1B, 1C), comprising:
a heat sink (2) elongated along a vertical direction (X);
a plurality of LEDs (3) supported by the heat sink (2), the LEDs (3) being spaced apart in the vertical direction (X), each LED (3) emitting light into an angular distribution centered around a respective surface normal (SN);
a cylindrical lens (6B, 6C) elongated along the vertical direction (X), the lens (6B, 6C) receiving a central portion of the light emitted from the LEDs (3) and transmitting the central portion therethrough, the lens (6B, 6C) altering the angular path of the transmitted light along a forward direction (Y) but not along the vertical direction (X), the lens (6B, 6C) having at least one asymmetric portion that produces an angular asymmetry of the transmitted light in the forward direction (Y) but not in the vertical direction (X); and
a pair of elongated, inclined surfaces (5) on the heat sink (2), each inclined surface (5) being elongated along the vertical direction (X) and being parallel to the vertical direction (X), each inclined surface (5) extending from a position proximate a lateral edge of the LEDs (3) to a position proximate a lateral edge of the lens (6B, 6C), the pair of inclined surfaces (5) opening away from the LEDs (3) toward the lens (6B, 6C), each inclined surface (5) receiving a peripheral portion of the light emitted by the LEDs (3) and diffusely reflecting the peripheral portion toward the lens (6B, 6C).

2. The replacement light module (1B, 1C) of claim 1, wherein in a cross-section taken perpendicular to the vertical axis (X), the lens (6B, 6C) is plano-convex, with a planar incident face (7B, 7C) facing the LEDs (3) and a convex exiting face (8B, 8C) facing away from the LEDs (3).

3. The replacement light module (1B, 1C) of claim 2, wherein the asymmetric portion of the lens (6B, 6C) comprises a protrusion on the convex exiting face (8B, 8C).

4. The replacement light module (1B, 1C) of claim 3, wherein when installed in a display case, the protrusion is present on a side facing a front of the display case but is absent on a side facing away from the front of the display case.

5. The replacement light module (1B, 1C) of claim 1, wherein the elongated, inclined surfaces (5) are flat.

6. The replacement light module (1B, 1C) of claim 1, wherein the heat sink (2) mechanically supports the lens (6B, 6C).

7. The replacement light module (1B, 1C) of claim 1, further comprising a plurality of pins (21) that mechanically support the heat sink (2) and electrically power the plurality of spaced LEDs (3).

8. The replacement light module (1B, 1C) of claim 1, further comprising at least one identifying mark (22) that identifies a proper orientation of the light module (1B, 1C) for mounting into a display case.

9. The replacement light module (1B, 1C) of claim 1, further comprising:
a display case (10) having an interior bounded by a front face (12), a rear face (14) and at least one lateral face (15), the front face (12) receiving light from the cylindrical lens (6B, 6C); and
at least one electrical socket (16) disposed in the interior of the display case (10), the at least one electrical socket mechanically supporting the heat sink (2) and electrically powering the LEDs (3).

10. The replacement light module (1B) of claim 1,
wherein the surface normals (SN) are all parallel to a lateral direction (Z) that is mutually orthogonal to the vertical direction (X) and the forward direction (Y); and
wherein when installed in a display case, the surface normals (SN) are parallel to a front face of the display case.

11. The replacement light module (1C) of claim 1,
wherein the surface normals (SN) are all angled with respect to a lateral direction (Z) that is mutually orthogonal to the vertical direction (X) and the forward direction (Y); and
wherein when installed in a display case, the surface normals (SN) of the LEDs (3) are angled toward a front of the display case.

12. The replacement light module (1B, 1C) of claim 1, wherein the cylindrical lens (6B, 6C) has a light output that has a single angular peak angled away from a lateral direction (Z), the lateral direction (Z) being mutually orthogonal to the vertical direction (X) and the forward direction (Y), the light output having decreasing values at angles above and below the angular peak.

13. The replacement light module (1B, 1C) of claim 1, wherein when installed in a display case, the light module (1B, 1C) has a light output that has a single peak, the single peak coinciding with a distal region of a front face of the display case, the distal region being most distal to the light module (1B, 1C) .

14. The replacement light module (1B, 1C) of claim 13, wherein the light output decreases monotonically to a proximal region on the front face, the proximal region being most proximal to the light module (1B, 1C).
